(19) United States
(12) Patent Application Publication
(10) Pub. No.: US 2021/0327233 A1
(43) Pub. Date: Oct. 21, 2021

(54) REINFORCEMENT ELEMENT AND METHOD FOR PRODUCING A REINFORCEMENT ELEMENT

(71) Applicant: RHENOFLEX GMBH, Ludwigshafen (DE)

(72) Inventors: Frank Boettcher, Haan (DE); Henritte Jaerger, Heuchelheim bei Frankenthal (DE); Sebastian Ames, Mannheim (DE)

(73) Assignee: RHENOFLEX GMBH

(21) Appl. No.: 17/273,175

(22) PCT Filed: Aug. 19, 2019
(86) PCT No.: PCT/EP2019/072167

§ 371 Date: Mar. 3, 2021

(30) Foreign Application Priority Data
Sep. 4, 2018 (DE) 10 2018 215 035.4

(51) Int. Cl. G08B 13/24; A43B 3/00

(52) U.S. Cl. CPC G08B 13/2445; A43B 3/0005; G08B 13/2434

(57) ABSTRACT

A reinforcing element, in particular for shoes, bags or orthopedic applications, comprises a support layer and a cover layer. A memory element such as a RFID chip, is arranged between the support layer and the cover layer. Also, a manufacturing method for such a reinforcing element.

### BACKGROUND

### 1. Field of the Disclosure

The disclosure relates to a reinforcing element suited in particular for shoes, bags, orthopedic applications or the like. The disclosure further relates to a method for producing such a reinforcing element.

### 2. Discussion of the Background Art

The use of RFID tags is known, e.g., with clothes. Here, RFID chips or other electronic memory elements are provided on clothes. The memory elements can be read by corresponding apparatus. Thereby, it is possible to clearly identify a piece of clothing and to thereby detect forgery. Moreover, information about the material, the manufacturing process and the like can be retrieved from the memory element. However, there is a problem that such memory elements as RFID chips are sensitive components so that they might be damaged during transport or by loads.

It is an object of the present disclosure to provide a suitable reinforcing element for reducing the risk of damage to a corresponding memory element. Further, it is an object of the disclosure to provide a corresponding method.

### SUMMARY

The reinforcing element of the disclosure is suited in particular for shoes, bags, orthopedic applications and the like. For shoes, the use of reinforcing elements made from different materials is known. For example, a reinforcement of the shoes in the region of the heel is effected by means of a rear cap or similarly by means of a front cap in the region of the toes. Likewise, with shoes, reinforcing elements are known in the region of the eyelets for the shoestrings to avoid tearing. With bags, such as handbags, sports bags or the like, such reinforcing elements are also provided in bags made of flexible material, e.g., in corners in the region of a strap fastening, bag bottoms and the like.

The reinforcing element of the present disclosure comprises a support layer, as well as a reinforcing layer. The reinforcing layer is connected with the support layer. The connection may be effected by providing an adhesive, wherein it is preferred that the material of the support layer and the reinforcing layer become connected by the application of pressure and/or heat. Therefore, the materials of the support layer and the reinforcing layer are preferably such that an in particular thermal bonding is possible, so that an additional provision of an adhesive is not required. In particular, the support layer and the reinforcing layer are made of the same or a chemically similar material. According to the disclosure, a memory element, such as an active or passive chip and in particular a RFID chip, is arranged between the support layer and the cover layer. Arranging the memory element between the support layer and the cover layer is advantageous in particular in that the memory element is protected by the two layers. The risk of damage during transport or also during use of the product is significantly reduced thereby. In this manner it is possible in particular to permanently provide such memory elements in products so that stored information can still be read even if the product has been in use in particular for some time already. It is particularly preferred for a reinforcing element for shoes to design the same as a cap, in particular as a rear cap. Another significant advantage of arranging the memory element between the support layer and the cover layer is that the memory element is not or only hardly visible.

The support layer and/or the cover layer may be made of rolled and/or plate material. For example, first a rolled material is produced from which corresponding plates are then cut. In this regard, suitable materials are, e.g., impregnated materials which may in particular be impregnated with latex dispersions and may possibly be provided with an adhesive layer on one or both sides. A production by extrusion of thermoplastic materials is also suitable, which materials may possibly include a filler such as wood powder, recycled material or the like. When the support layer and/or the cover layer are produced from such plate material, the corresponding shaped parts for forming the reinforcing element are, e.g., punched or cut out. If the support layer and the cover layer are made of plate material, they may then be glued to each other or, in particular, be connected by application of heat and pressure.

In a particularly preferred embodiment of the reinforcing element of the present disclosure the support layer and/or the cover layer are made of a powder. Thereby, it is possible, e.g., to arrange, using a slider and a template, a powder already in the desired final shape of the support layer and/or the cover layer, and to compound it by the application of pressure and/or heat. The manufacture of the support layer and/or the cover layer using powder is advantageous in particular in that the process step of punching or cutting out the support layer and/or the cover layer from plate-shaped material is omitted. Further, a manufacture from powder has the advantage that no waste is produced. In a particularly preferred embodiment, it is possible to shred elements produced with faults, in particular to grind them and reuse the material. In particular powdery thermoplastic material is suited as a corresponding material. The same may be produced, e.g., by grinding granulate. A preferred powder size is in the range from 50 μm to 900 μm, preferably 50 μm to 600 μm. A suitable production method is described in particular in EP 0 222 2213 B1, as well as WO 2012/059367.

The plastic material may possibly include a filler, such as, e.g., polycarbonate, PET or other fillers.

Of course, a cover layer and/or a support layer made from granulate by an extrusion method or from powder by the method described above can be given the final shape by cutting or punching. If need be, a slight finishing, such as cleaning the edges, may be useful.

Likewise, combinations of different support layers and cover layers are also possible, so that, e.g., the support layer is made from a granulate or powder and is then connected to a cover layer of plate material.

It is further possible to produce the support layer and/or the cover layer using a 3D printing method. In this regard, the FDN method as well as the SLS method are particularly suitable. Again, combinations of differently produced support layers and cover layers are possible. Here, in particular both layers can be produced using the same above-mentioned method, while it is also possible to manufacture the two layers by different methods and, after having placed a memory element between the two layers, to connect them after and/or during the manufacturing process.

In a preferred development of the reinforcing element of the present disclosure, an adhesive film is provided on an outer side of the support layer and/or the cover layer. The outer side is that side of the support layer and/or the cover layer that is positioned on the outer side after the two inner sides of the support layer and/or the cover layer have been connected. Providing an adhesive film on at least one of the two outer sides has the advantage that a good bonding of the reinforcing element to a cover material or another material layer is possible thereby. This may, e.g., be the material of the shoe or the bag, e.g., a layer of leather, a textile fabric layer or the like. When providing an adhesive layer on at least one of the outer sides of the support layer and/or the cover layer, it is particularly advantageous that, according to the disclosure, the memory element is arranged between the support layer and the cover layer, since thus the adhesive layer or the adhesive film is not arranged on the memory element. This is advantageous, on the one hand, in that damage to the memory element by the adhesive is avoided and, on the other hand, it is advantageous in that a surface connection between the outer side of the support layer or the cover layer with the corresponding material is possible. Otherwise, there would be a risk of detaching at least in the region of a memory element arranged on an outer side of the support element and/or the cover element.

Instead of providing an adhesive film it is also possible, depending on the material used, to realize bonding by thermal activation of the outer side of the support layer and/or the cover layer.

The method of the disclosure for producing a reinforcing element is suited in particular for producing the above described reinforcing element. Especially in the method of the disclosure it is possible produce in particular reinforcing elements for shoes, bags, orthopedic applications and the like. According to the disclosure a cover layer is connected to a support layer. These are, as described above with respect to the reinforcing element, made from corresponding materials. Further, the cover layer and/or the support layer preferably are layers made of a plate material or directly from powder.

A memory element, such as an active of passive chip and preferably a RFID chip, is arranged between the cover layer and the support layer. For this purpose, the memory element is arranged on an inner side of the support layer or an inner side of a cover layer before the cover layer is connected with the support layer. The inner side of the support layer as well as the cover layer are those sides or surfaces facing of the layers that face each other and which will be connected with each other. The connection can be achieved by providing an adhesive, by temperature and/or by pressure.

The reinforcing element can be produced such that a large-surface, in particular roll-shaped support layer is provided. Thereafter, a roll-shape or similarly shaped cover layer is placed on this support layer. Before this, memory elements are arranged at defined positions on the inner side of the support layer or the cover layer. By connecting the two layers a roll-shaped planar material is obtained, having memory elements arranged at predetermined positions. Subsequent thereto, reinforcing elements can be punched out, so that the memory elements are arranged in the reinforcing element. The punching, cutting out or the like of the reinforcing elements can be affected immediately after the production of the raw material, so that the corresponding reinforcing elements are delivered to a customer that uses them, e.g., to manufacture shoes, bags or orthopedic applications or the like. Further, the punching or cutting out of the reinforcing elements can be performed by the customer himself, so that rolled material is shipped to the customer. It is further possible to cut the rolled material such that plate-shaped material is obtained. The plates may then be shipped to a customer who will produce the corresponding reinforcing elements from the plate-shaped material, e.g., by punching or cutting.

In a particularly preferred use of powder particles, the reinforcing element is preferably produced such that the powder particles are arranged in one layer at least substantially in a final shape of an outer contour of the support layer and/or the cover layer. Thereafter, a separate production of the support layer and the cover layer can be performed by application of temperature and/or pressure. Two separate elements, i.e., the support layer and the cover layer, are thus obtained. In the next step they can be joined by their inner sides, with the memory element being arranged before on an inner side of the support layer or the cover layer. In particular when the support layer and the cover layer are made from the same material, it is possible in a simple manner to join them using temperature and/or pressure so that the provision of adhesive material is not required. According to a preferred development the memory element can be placed into the not yet compounded or compacted powder, and thereafter the corresponding support and/or cover layer is produced by applying pressure and/or temperature, which layer then already includes the memory element. This is advantageous in that the memory element is pressed into the corresponding layer. However, this method is possible only with memory elements that are not damaged by the pressure and the temperature occurring in the manufacturing process.

Further, it is possible to arrange a memory element on a support layer and to then provide the powder of the cover layer on the support layer, with the powder then covering the memory element. In the next step, the powder particles are compacted or compounded by the application of heat and/or pressure. Here, the support layer is preferably connected directly with the cover layer while the cover layer is produced. Such a method has the advantage that the memory element is protected by the powder while it is produced and, as such, the temperature and the pressure applied are lower. In this method, the support layer can be produced beforehand and may consist, e.g., of a plate material. The plate-shaped material can be cut or punched to its final shape already, which may, e.g., also be done after the application of the cover layer. In a particularly preferred development, the support layer is made from a powder which may already be compounded or compacted or not.

It is particularly preferred to arrange powder for a support layer, but to not yet compound the powder particles. In the next step the memory element is arranged on the inner side of the support layer still consisting of loose powder. Thereafter, the powder for the cover layer is applied. Subsequently, the powder is compounded by applying temperature and/or pressure. Thereby, a reinforcing element is created which, in particular, is made from a single material, wherein, after the manufacturing process, the memory element is arranged on the inside of the reinforcing element.

The disclosure will be described hereafter in more detail with reference to preferred embodiments and the accompanying drawings.

### BRIEF DESCRIPTION OF THE DRAWINGS

In the Figures:

FIG. 1 is a schematic view of a first embodiment for producing a reinforcing element of the present disclosure,

FIG. 2 is a schematic view of a second embodiment for producing a reinforcing element of the present disclosure, and

FIG. 3 is a schematic view of a third embodiment for producing a reinforcing element of the present disclosure.

### DETAILED DESCRIPTION OF THE PREFERRED EMBODIMENT

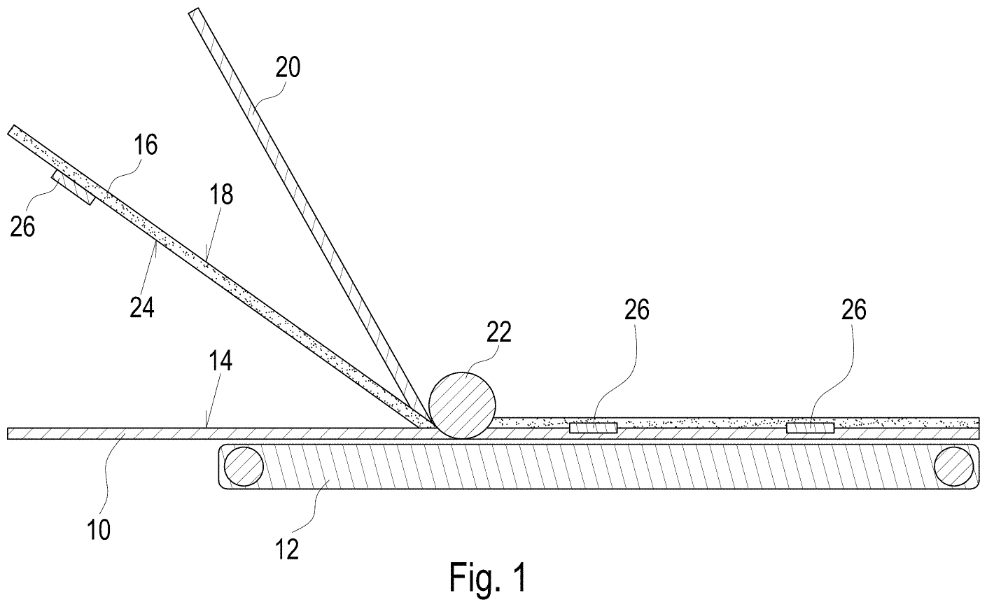

For producing a reinforcing element, it is possible, according to a first embodiment (FIG. 1) to provide a plate- or band-shaped support material as the support layer 10. The same can be moved from the left to the right in FIG. 1 using a conveyor belt 12 or another suitable transport device. A cover layer 16 supplied via suitable supply rollers is arranged on an inner side 14 of the support layer 10. Preferably, an adhesive film, also supplied by suitable supply devices, is arranged on an outer side 18 of the cover layer.

The connection of the support layer 10, the cover layer 16 and the adhesive film 20 is effected, e.g., using pressure and preferably temperature applied via a roll 22. The necessary pressure, possibly together with the temperature necessary for melting, can also be applied via possibly heated dies or band plates or the like.

In the previous method step a memory element 26, such as a RFID chip, has been arranged on an inner side 24 of the cover layer 16. Likewise, it would be possible to arrange memory elements 26 on the inner side 14 of the support layer 10.

In a next step, the reinforcing element can be produced by punching or cutting so that reinforcing elements are produced which each have at least one memory element 26 arranged inside, i.e., between the support layer 10 and the cover layer 16.

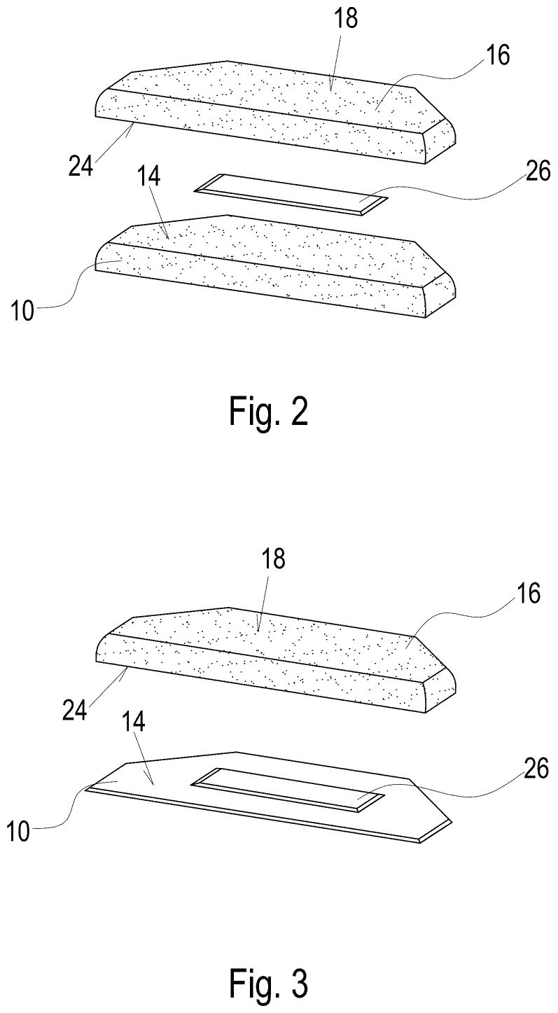

In an alternative embodiment of the present disclosure (FIG. 2), the support layer 10, as well as the cover layer 16 are produced from powdery material. In this regard, different approaches are possible. For example, the support layer 10 and the cover layer 16 may be produced such that they already exist in their final form and are compacted or joined by the application of pressure and temperature. Thereafter, the memory element 26 can be arranged between the layers before the inner sides 14 and 24 of the two layers 10, 16 are connected. The connection of the support layer 10 with the cover layer 16 may be effected by temperate and/or pressure. This is possible in particular if the two layers are made of the same or compatible powder materials.

As an alternative, the support layer 10 made of powder can be finished and, in the next step, the memory element 26 can be arranged on the upper side 14 of the support layer and, thereafter, powder for the cover layer 16 can be arranged on the inner side 14 of the support layer 10. Subsequently, the powder of the cover layer 16 is compacted or compounded by the application of temperature and/or pressure. The memory element 26 was again arranged beforehand on the inner side 14 of the support layer 10 so that, in the finished reinforcing element, the memory element 26 is arranged inside the reinforcing element.

It is particularly preferred to not yet compound or compact the powder of the support layer 10, but to first arrange the memory element 28 on the inner side 14 and to cover it with powder for the cover layer 16. Thereafter, the powder of the support layer 10 and the powder of the cover layer 16 are compounded or compacted together by application of temperature and/or pressure.

In a further alternative embodiment (FIG. 3) the support layer 10 is made from a plate material. In the embodiment illustrated the support layer 10 already has the final outer contour which was obtained, e.g., by cutting or punching. Possibly, obtaining the outer contour can also be performed as the last manufacturing step.

The memory element 26 is arranged on the inner side 14 of the support layer 10. Thereafter, the powdery material for forming the cover layer 16 is applied. If so desired, the inner side 14 can be coated with a bonding agent to ensure a reliable connection between the support layer 10 and the cover layer 16. After the powder of the cover layer 16 has been arranged on the inner side 14 of the support layer 10, temperature and/or pressure are again applied to form the cover layer. Here, it is particularly preferred that a direct connection of the cover layer 16 with the support layer 10 is obtained so that the provision of a bonding agent is not necessary.

If so intended, the support layer 10 and/or the cover layer 16 can also be produced by a 3D printing method, in particular a FDM method or a SLS method, with combinations of the different manufacturing methods being possible.

What is claimed is:

1. Reinforcing element, in particular for shoes, bags or orthopedic applications, comprising
a support layer, and
a cover layer connected with the support layer,
a memory element arranged between the support layer and the cover layer.

2. Reinforcing element of claim 1, wherein the support layer and/or the cover layer are produced from a prefabricated material, in particular plate material or rolled material.

3. Reinforcing element of claim 1, wherein the support layer and/or the cover layer are made from a powdery material.

4. Reinforcing element of claim 1, wherein an outer contour of the support layer and/or the cover layer is obtained by punching and/or cutting.

5. Reinforcing element of claim 1, wherein an outer contour of the support layer and/or the cover layer is obtained directly during manufacture.

6. Reinforcing element of claim 1, wherein an adhesive layer is provided on an outer side of the support layer and/or the cover layer.

7. Reinforcing element of claim 1, wherein the memory element is configured as an active or passive chip.

8. Method for producing a reinforcing element, in particular for shoes, bags or orthopedic applications, in which
a cover layer is connected with a support layer, and
a memory element is arranged between the cover layer and the support layer by arranging the memory element on an inner side of the support layer or an inner side of the cover layer prior to connecting the cover layer and the support layer.

9. Method for producing a reinforcing element of claim 8, in which the support layer and/or the cover layer are made of prefabricated plate material or rolled material.

10. Method for producing a reinforcing element of claim 8, in which the support layer and/or the cover layer are made from a powdery material.

11. Method for producing a reinforcing element of claim 10, in which powder particles are arranged in one layer at least substantially in the final shape of an outer contour of the support layer and/or the cover layer.

12. Method for producing a reinforcing element of claim 11, in which the memory element is arranged on/in the support layer of powder particles prior to compounding the powder particles.

13. Method for producing a reinforcing element of claim 11, in which a layer of powder particles for forming the cover layer is arranged on the support layer formed by powder particles, wherein the memory element has been arranged on the inner side of the support layer beforehand.

14. Method for producing a reinforcing element of claim 10, in which the powder particles are compounded by applying heat and/or pressure.

15. Method for producing a reinforcing element of claim 8, in which the support layer and/or the cover layer are produced separately and the support layer and the cover layer are connected with each other after the memory element has been positioned.

16. Method for producing a reinforcing element of claim 8, in which the support layer and the cover layer are produced together, wherein the memory element is arranged between the support layer and the cover layer beforehand.

17. Method for producing a reinforcing element of claim 8, in which the memory element is arranged on the support layer of prefabricated plate-shaped material.

18. Method for producing a reinforcing element of claim 17, in which the cover layer is arranged on the support layer by depositing a layer of powder particles.

19. Reinforcement element of claim 7, wherein said active or passive chip a RFID chip.
